(19) United States
(12) Patent Application Publication
(10) Pub. No.: US 2014/0239013 A1
(43) Pub. Date: Aug. 28, 2014

(54) WATER COOLER ADAPTER

(71) Applicant: Ernest Santos, Honolulu, HI (US)

(72) Inventor: Ernest Santos, Honolulu, HI (US)

(21) Appl. No.: 14/210,485

(22) Filed: Mar. 14, 2014

Related U.S. Application Data
(63) Continuation-in-part of application No. 13/079,028, filed on Jun. 27, 2011.
(60) Provisional application No. 61/852,203, filed on Mar. 14, 2013.

(51) Int. Cl. B67D 3/00

(52) U.S. Cl. CPC B67D 3/0009; B67D 3/0032
USPC 222/146.6; 141/18

(57) ABSTRACT

The invention provides adapters, coolers comprising an adapter, and methods for using an adapter. In one aspect, the invention provides an adapter configured for coupling a bottle to a beverage container. The beverage container is optionally a high-capacity container, a wide-mouth container, or both (e.g. a common 5 gallon container). Optionally, the bottle is a 5 gallon water bottle.

### CROSS-REFERENCE TO RELATED APPLICATIONS

The application claims priority to U.S. Provisional Application No. 61/852,203 filed 14 Mar. 2013 and is a continuation-in-part of U.S. application Ser. No. 13/079,028 filed 27 Jun. 2011.

### TECHNICAL FIELD

The present invention relates to beverage containers.

### BACKGROUND

Nothing is more refreshing on a hot day than a drink of ice-cold water. In many instances, such a drink is provided by 5 gallon water coolers, which are containers seen nearly universally on the sidelines of sporting events and in other outdoor activities. These outdoor 5 gallon water coolers are cylindrical or substantially cylindrical in shape and are typically formed from a layer of insulation sandwiched between layers of plastic. With a wide mouth and respectively large lid to cover, the five gallon capacity can easily be filled with ice and the beverage. This is often the container of choice when electricity is not available for refrigerator-type coolers.

While the common 5 gallon coolers perform well under normal conditions, they can fall short when trying to serve a large amount of people at one time. The 5 gallon capacity frequently becomes inadequate when serving a large number of people. Should service staff be unavailable to do an immediate refill, athletes and other outdoor workers will go thirsty. This could spell disaster for an overheated athlete that approaches an empty water cooler.

In indoor environments, electric office water coolers are often used. The office water coolers have a collar that holds the neck of a 5 gallon water bottle (also known as a ‘water jug’) and feeds the water to a small electric refrigerator container, for example, as disclosed by U.S. Pat. No. 4,874,023 (John Ulm; 1989) and U.S. pat. No. 6,167,921 (Busick et al.; 2001). Although Busick et al. describe a mounting adapter configured for receiving a water bottle, Busick et al. do not describe an adapter configured to fit the common outdoor 5 gallon water cooler. Further, these electric office water coolers contain a very small reservoir that empties with just a few servings when the water bottle is depleted. They do not provide an ample supply of water during the interim before replacing the water bottle.

What is needed in the art is an improved system for delivering beverages to people outdoors.

### SUMMARY OF THE INVENTION

The invention provides adapters, coolers comprising an adapter, and methods for using an adapter.

In one aspect, the invention provides an adapter configured for coupling a bottle to a beverage container. The beverage container is optionally a high-capacity container, a wide-mouth container, or both (e.g. common 5 gallon container).

In one embodiment, the adapter comprises:
a lid configured to cover a container, wherein the lid comprises an external side and a luminal side;
a collar configured to receive the neck of a water bottle,
a flow tube configured to transmit liquid between from the lumen of a bottle, when inserted, and the luminal side of the lid.

Optionally, the container is any of: a wide mouth container, a high-capacity container, and a substantially cylindrical container.

Optionally, the adapter comprises a breather configured to transmit air to the lumen of a bottle, when inserted. For example, the breather can be configured to transmit air from the luminal side of the lid (i.e. the side of the lid that faces the inside of the container), the external side of the lid (i.e. the side of the lid that faces the external environment), or both. Optionally, the breather comprises an air tube positioned about the flow tube. Optionally, the adapter comprises a common housing comprising the flow tube and the air tube, wherein the common housing is configured as a tube connecting the luminal side and external side, and extends out on the external side of the lid through the collar. Optionally, the breather comprises a second air tube configured to transmit air from the external side at a location outside the collar to the luminal side of the lid.

Optionally, the lid is substantially circular in cross-section. Optionally, the lid has a diameter of greater than about 8 inches. Optionally, the lid diameter is greater than any of: about 9 inches, about 10 inches, about 11 inches, and about 12 inches. Optionally, the lid diameter is less than about 18 inches. Optionally, the diameter is greater than about 8 inches and less than about 15 inches. Optionally, the lid diameter is between about 10 inches and about 15 inches. Optionally, the diameter is between about 11 inches and about 14 inches.

Optionally, the lid further comprises a lip. Optionally, the lid comprises a lip of less than about 3 inches. Optionally, the lip is less than about any of: 2.5 inches, 2 inches, or 1.5 inches. Optionally, the lip is between about 0.5 inches and 2 inches.

Optionally, the bottle is a 5 gallon water bottle.

Optionally, the high-capacity container is a common 5 gallon water cooler.

Optionally, the adapter further comprises a removable cover configured to cover the flow tube. Optionally, the removable cover comprises a member shaped like the neck of the bottle and comprises a cavity configured to accept the flow tube. Optionally, the removable cover is configured to cover the collar. Optionally, the removable cover is configured to cover the collar and comprises a member shaped like the neck of the bottle and a cavity configured to accept the flow tube. Optionally, the cover comprises a handle.

In another aspect, the invention provides a cooler comprising a high-capacity beverage container, and an adapter configured for coupling a bottle to the high-capacity beverage container. The adapter is can be, e.g. any adapter set forth above.

Optionally, the high-capacity container has a capacity of at least about 2 gallons, at least about 3 gallons, or at least about 5 gallons. Optionally, the high-capacity container has a capacity of any of: about 2 gallons, about 3 gallons, and about 5 gallons.

Optionally, the cooler further comprises the bottle. Optionally the bottle is a 5 gallon bottle.

Optionally, the high-capacity container is substantially cylindrical. For example, the high-capacity container is optionally a common 5 gallon cooler.

Optionally, the high-capacity container has a shell comprising a luminal layer and an external layer. Optionally, the shell further comprises an insulation layer between the luminal layer and the external layer. Optionally, the insulation layer comprises air or a solid material. Optionally, the solid material comprises a foam, a polymer, or a polymer foam (e.g. polyurethane foam).

Optionally, the high-capacity container comprises one or more handles.

In another aspect, the invention provides a method comprising a step of coupling a bottle to a high-capacity container using an adapter of the invention.

Optionally, the adapter is any adapter taught herein (e.g. as described above).

Optionally, the method produces any cooler taught herein (e.g. as described above).

### BRIEF DESCRIPTION OF THE DRAWINGS

FIG. 1 depicts a cooler of the invention comprising a high-capacity container, an adapter, and a bottle.

FIG. 2 depicts an exploded view of the cooler depicted in FIG. 1.

FIG. 3A FIG. 3C depict an adapter of the invention. FIG. 3A shows the top perspective view. FIG. 3B shows the side view. FIG. 3C shows the bottom perspective view.

FIG. 4A and FIG. 4B depict section views of an adapter of the invention. FIG. 4A shows the side view. FIG. 4B shows a perspective view.

FIG. 5 depicts a side view showing dimensions of examplary parts.

FIG. 6A and FIG. 6B depict views of a removable cover optionally useful on an adapter of the invention.

FIG. 7 depicts a common 5 gallon bottle.

FIG. 8A and FIG. 8B depict an adapter comprising a removable cover configured to cover the flow tube.

FIG. 9 depicts a common 5 gallon cooler with lid.

FIG. 10 depicts an adapter of the invention comprising a lid with a three layer configuration.

FIG. 11A and FIG. 11B depict an adapter of the invention comprising a screw cap type lid having an external lip. FIG. 11A is a section view.

FIG. 12A-FIG. 12D depict an embodiment of an ornamental design for a cooler. FIG. 12A depicts a perspective view. FIG. 12B depicts a top view. FIG. 12C depicts a front view. FIG. 12D depicts a front view. The bottom can be, e.g. plain and unornamented. The dashed lines represent portions that are optionally part of the ornamental design (e.g. illustrate environmental structures). Additionally, the bottle 3 is an optional part of the claimed design (i.e. the bottle in the drawing can be reduced to dashed lines as an environmental structure). The surface can be plane and unornamented or can have any surface decoration or texture (e.g. patterns such as ribs). Accordingly, the drawing of the surface portion of the cooler or adapter can optionally be modified to comprise dashed lines to show that the surface is not part of the ornamental design. Optionally, the bottom and rear side are unclaimed or are plain and unornamented.

### DETAILED DESCRIPTION OF THE INVENTION

As used here, the following definitions and abbreviations apply.

“Examplary” (or “e.g.” or “by example”) means a non-limiting example.

“High-capacity container” means a container having a capacity of 2 or more gallons. Optionally, the high capacity container has a capacity of about 3 or more gallons (e.g. about 5 gallons). Optionally, the high-capacity container is substantially cylindrical. Optionally, the high-capacity container is a wide-mouth container (e.g. a common 5 gallon cooler). Optionally, a cooler of the invention comprises a high-capacity container and a water bottle (e.g. a water bottle having a 5 gallon capacity). In such a cooler, the total capacity of the cooler is the sum of the capacity (i.e. volume) of the container and the capacity (i.e. volume) of the water bottle.

“Wide-mouth container” a container comprising a mouth with a diameter of at least about 8 inches. Optionally, the mouth of the wide-mouth container has a diameter of at least about 9 inches or at least about 10 inches (e.g. a common 5 gallon cooler).

In one aspect, the invention provides an adapter configured for coupling a water bottle to a beverage container.

The adapter can be made of any material. For example, the adapter can be made of any plastic or any metal. Optionally, the adapter is made of any material that can support the weight of at least 5 gallons of water.

The adapter comprises a lid configured for a container. The container is optionally any of a wide-mouth container, a high-capacity container, a common 5 gallon cooler, and/or a substantially cylindrical container.

The adapter can have any dimensions, e.g. as depicted in FIG. 5. For example, the adapter can have a lid with diameter Z, a collar with diameter X, and a projection with diameter Y.

Optionally, diameter Z of the lid is at least about 8 inches. For example, the diameter Z can be any of: at least about 9 inches, about 9 inches to about 20 inches, about 9 inches to about 18 inches, about 9 inches to about 15 inches, about 9 inches to about 13 inches, about 13 inches to about 20 inches, about 10 inches to about 18 inches, about 10 inches to about 15 inches, or about 10 inches to about 13 inches. An adapter with a lid of any of such diameters of Z is useful for a wide-mouth container. Optionally, the diameter Z is configured for a common 5 gallon cooler (e.g. about 10 inches to about 15 inches).

Optionally, the diameter X of the collar is at least about 2.5 inches. For example, X can be any of: about 2.5 inches to about 3.5 inches, or about 2.5 inches to about 3 inches, about 2.5 inches, and about 3 inches. An adapter with a collar of any of such diameters of X is useful for receiving the neck of a 5 gallon water bottle.

Optionally, the diameter Y of the projection which comprises the flow tube is at least ½ inches in diameter. For example, the diameter Y can be any of: less than about 2½ inches, about ¾ inches to about 2½ inches, about ½ inch to about 1½ inches, or about ¾ inches. An adapter with a projection of any of such diameters of Y is useful for extending into the neck of a bottle (e.g. 5 gallon water bottle), e.g. through a hole 3.2 in the neck 3.1.

Optionally, the collar of the adapter comprises a substantially cylindrical portion with a height of W, as depicted in FIG. 5. Optionally, W is at least about 2 inches, e.g. about 2.5 inches. An adapter with such a cylindrical portion height W is useful, e.g. for receiving the neck of a 5 gallon water bottle.

Optionally, the lid of the adapter comprise an internal lip (i.e. a lip configured to sit in the mouth of a container) with offset V, as depicted in FIG. 5. For example, V can be any of: less than about 3 inches, less than about 2 inches, less than about 1.5 inches, about 0.5 inches to about 3 inches, about 0.5 inches to about 2 inches. Such an adapter is useful for providing a lid that sits down in the lumen of a container (e.g. common 5 gallon container or other wide-mouthed container).

Optionally, the lid of the adapter comprises a luminal portion with a diameter of U, as depicted in FIG. 5. Optionally, U is at least about 8 inches. For example, U can be any of: at least about 9 inches, at least about 10 inches, about 9 to about 19 inches, about 10 to about 13 inches, about 9 to about 12 inches, or about 9 inches to about 11 inches, about 10 to about 12 inches or about 10 to about 11 inches. Such an adapter is useful, e.g. for a wide-mouth container (e.g. a common 5 gallon cooler). Optionally, the luminal portion is configured for a common 5 gallon cooler (e.g. with diameter U of about 9 inches to about 11 inches). Optionally, the luminal portion is configured to provide a snug fit in the lumen of a container (e.g. wide mouth container or common 5 gallon cooler).

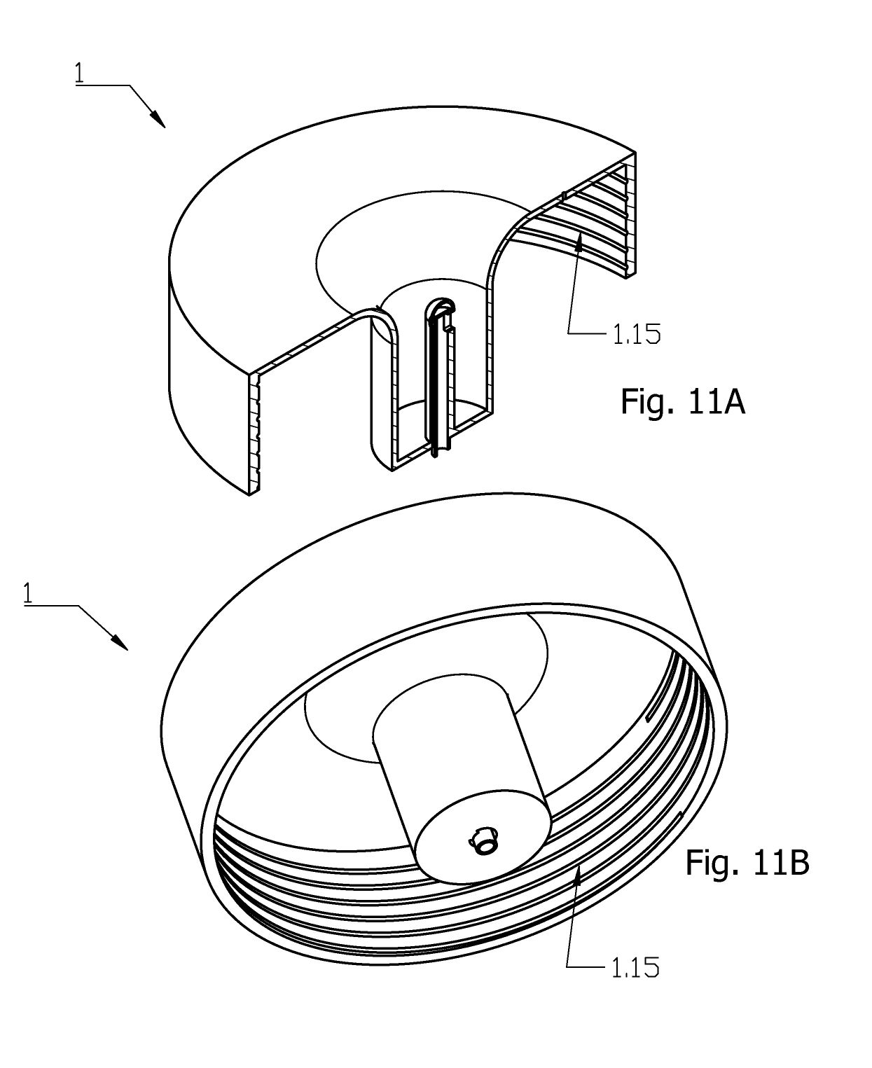

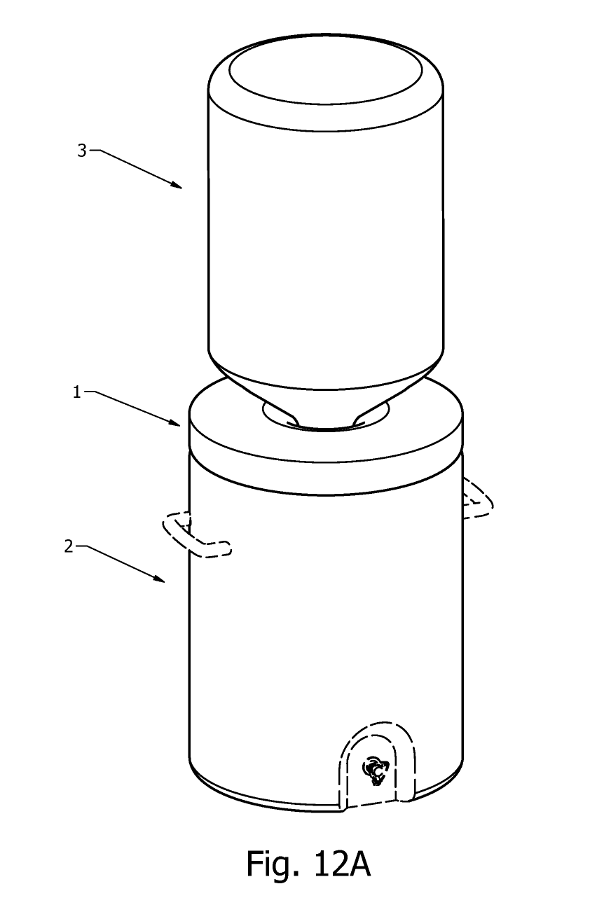

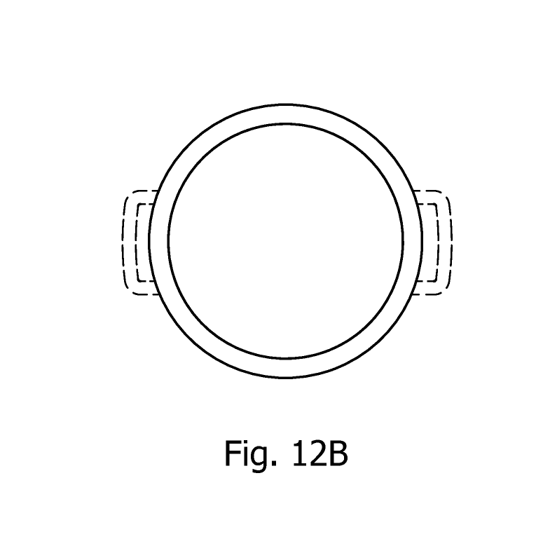

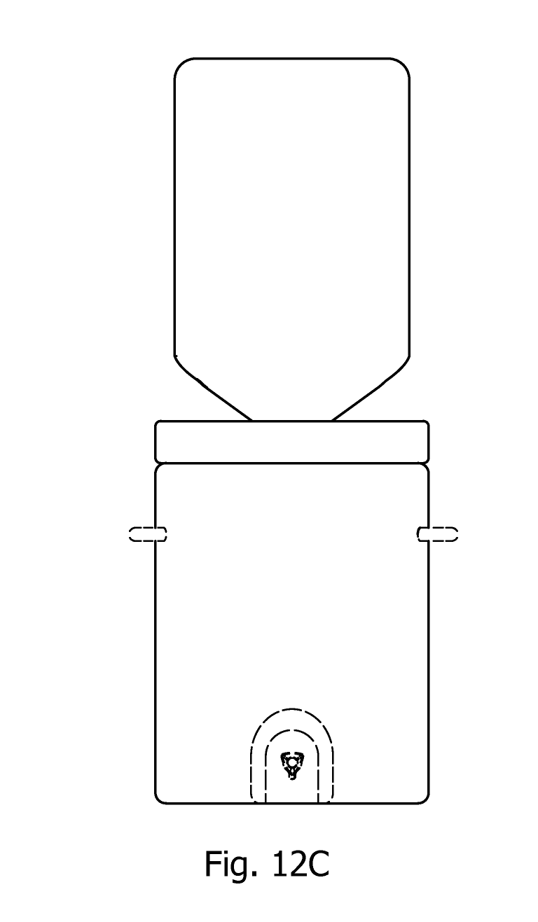

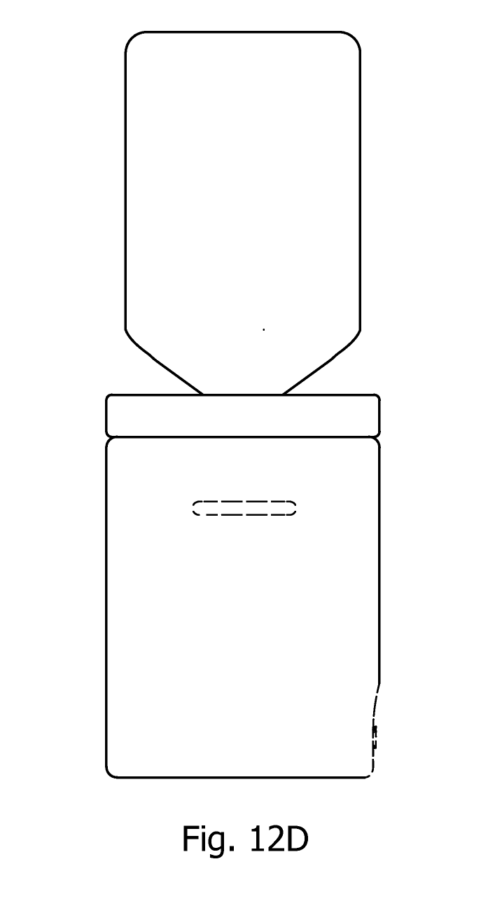

Optionally, the lid of the adapter comprise threads, e.g., as depicted in FIG. 11B. For example, the lid can comprise threads 1.15 for screwing the adapter down on a container comprising threads positioned about the mouth of the container.

Optionally, the collar is configured in any manner to receive the neck of a bottle (e.g. 5 gallon water bottle). The adapter can comprise a projection that extends up through the collar, wherein the projection houses a flow tube and an airtube. Such a projection and collar is well known in the art for office coolers which are configured to receive a common 5 gallon water bottle. Examples of useful configurations for a collar, projection, flow tube, and/or air tube are disclosed by U.S. Pat. No. 6,167,921 (Busick et al.; 2001), which is hereby incorporated by reference.

Optionally, the lid of the adapter is configured in any manner that allows the adapter to sit on the container mouth and/or to be supported by the container while resting about the container mouth. Optionally, the lid is configured to provide any of: a liquid barrier, a gas barrier, a debris barrier, or an ambient light barrier to the lumen of the container when installed.

In one embodiment, the invention provides a cooler comprising a high-capacity container and an adapter of the invention configured for the high-capacity container.

Optionally, the container has a capacity of any of: at least about 3 gallons, at least about 5 gallons, at least about 10 gallons, about 3 gallons to about 20 gallons, about 5 gallons to about 20 gallons, or about 3 gallons to about 10 gallons.

Optionally, the container is a wide mouth container. For example, the container can have a mouth of at least about 9 inches, or at least about 10 inches. Optionally, the adapter comprise a luminal portion with a diameter U approximately equal to the diameter of the mouth of the container, e.g. to provide a snug fit.

Optionally, the container comprises at least two layers, a luminal layer and an external layer. Optionally, the two layers are made of the same or different materials such as plastics. Optionally, the external layer comprises high density polyethylene and/or the luminal layer comprises polypropylene. Optionally, the container further comprises a third layer comprising insulation (e.g. a foam insulation or a vacuumed space).

Optionally, the cooler further comprises the bottle. For example, the bottle can be a 5 gallon water bottle shaped, e.g. as depicted in FIG. 7. Optionally, the bottle has a neck 3.1 with a diameter of about 2.5 inches. Although a hole of any diameter can be provided, optionally, the neck 3.1 has a hole (e.g. provided by a cap with a hole), e.g. with a hole diameter of about ¾ inch.

In another aspect, the invention provides a method comprising a step of coupling a bottle to a high-capacity container using an adapter of the invention.

Optionally, the adapter is any adapter taught herein (e.g. as described above).

Optionally, the method produces any cooler taught herein (e.g. as described above).

In one embodiment, the invention provides a method comprising a step of coupling a bottle to a high-capacity container using an adapter of the invention.

Optionally, the adapter is any adapter taught herein (e.g. as described above).

Optionally, the method produces any cooler taught herein (e.g. as described above).

Optionally, the container is a common 5 gallon cooler or a 10 gallon container.

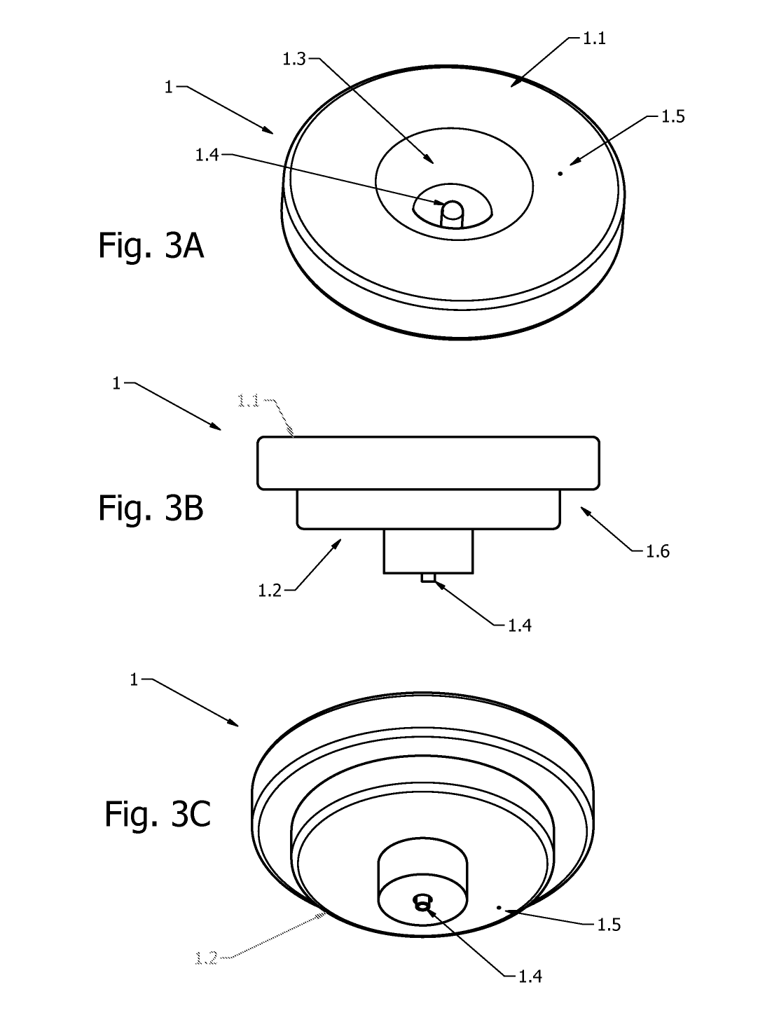

The adapters and containers of the invention can be provided in any configuration. Optionally, the adapter comprises a lid that is substantially circular as depicted in FIGS. 3A-3C. Such an adapter is useful for containers that are substantially cylindrical, e.g. a common 5 gallon cooler. Alternatively, the lid of the adapter is any shape, e.g. square, rectangular, star shaped, or any regular or irregular polygon. Such adapters are useful, e.g. for containers that have a mouth with substantially the same shape as the lid. Accordingly, for teachings herein made with respect to a “diameter” value (e.g. the diameter of a container mouth or lid), the invention contemplates an alternative embodiment wherein the part (e.g. adapter and/or container) is not circular, and the “diameter” value is to be understood as the width of the part (e.g. the greatest width of its cross-section).

The containers and adapters of the invention are often described and illustrated herein with respect to 5 gallon water coolers and 5 gallon water bottles. However, the invention alternatively contemplates adapters with a lid configured for any container (e.g. large or wide mouth container) and/or adapters with a collar (or flow tube projection) configured for any bottle or bottle neck.

Among the many advantages of the invention are the following:
a. Ability to increase the capacity of a container, e.g. turns a 5 gallon cooler into a 10 gallon cooler;
b. Can be used, e.g. to retrofit a wide mouth water cooler to mount a water bottle
c. Provides the ability to fill a wide mouth container with ice (e.g. fill a cooler with 5 gallons of ice at an outdoor location that is not in proximity to power outlets), cover with the adapter of the invention, and mount an inverted water bottle
d. Extends Time Between Refilling
e. Eliminates down-time for refilling. When bottle runs out, the container is still full.
f. Allows More People to Be Served beverages
g. Provides an efficient gravity-fed mechanism of feeding water through the collar;
h. Adapter is easily installed in place of an existing container lid
i. Allows container to Be Converted Back to its standard capacity simply by removing adapter and replacing back with original lid.
j. Can Be Adapted For Use With Any Common Type Of Cooler.
k. Can be used to events such as sporting events, outdoor events, and catered parties with less staff to monitor and refill beverage coolers.
l. Allows large volumes of water to be transported to a remote site via water bottles and then easily fed into a cooler using the adapter.

### EXAMPLES

Among the many advantages of the invention The following examples are non-limiting illustrations of various aspects of the invention.

### Example 1

### Adapter of the Invention

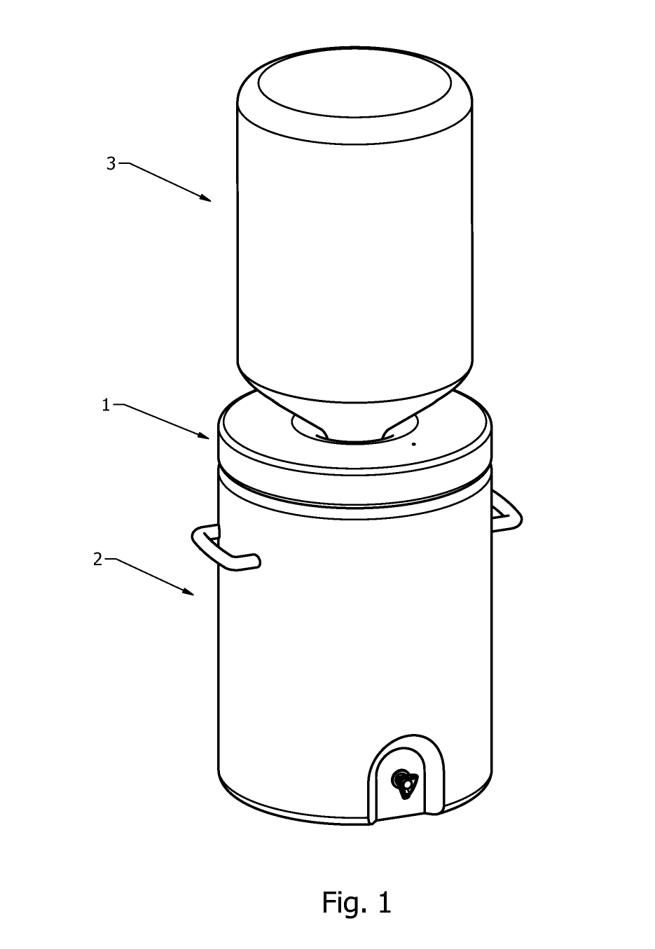

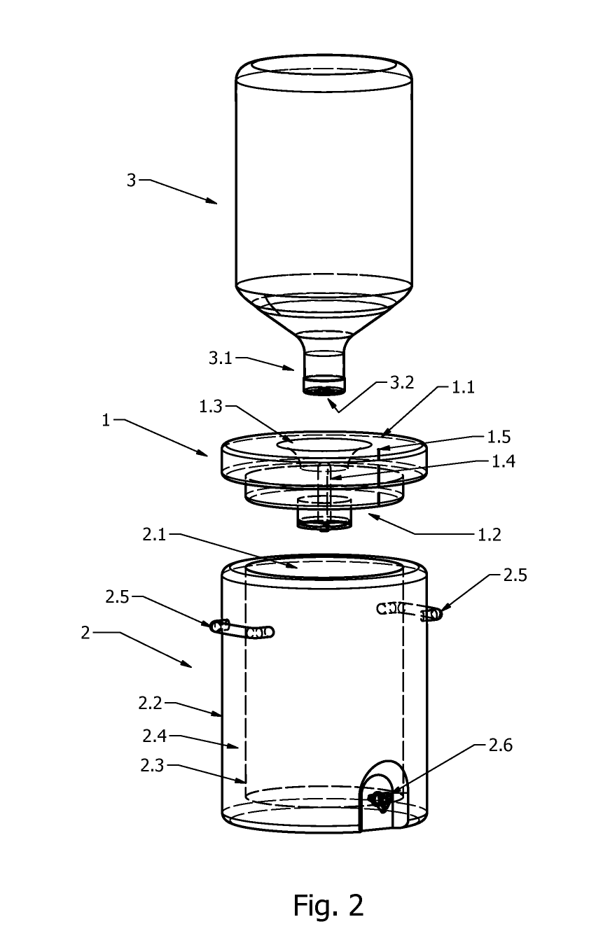

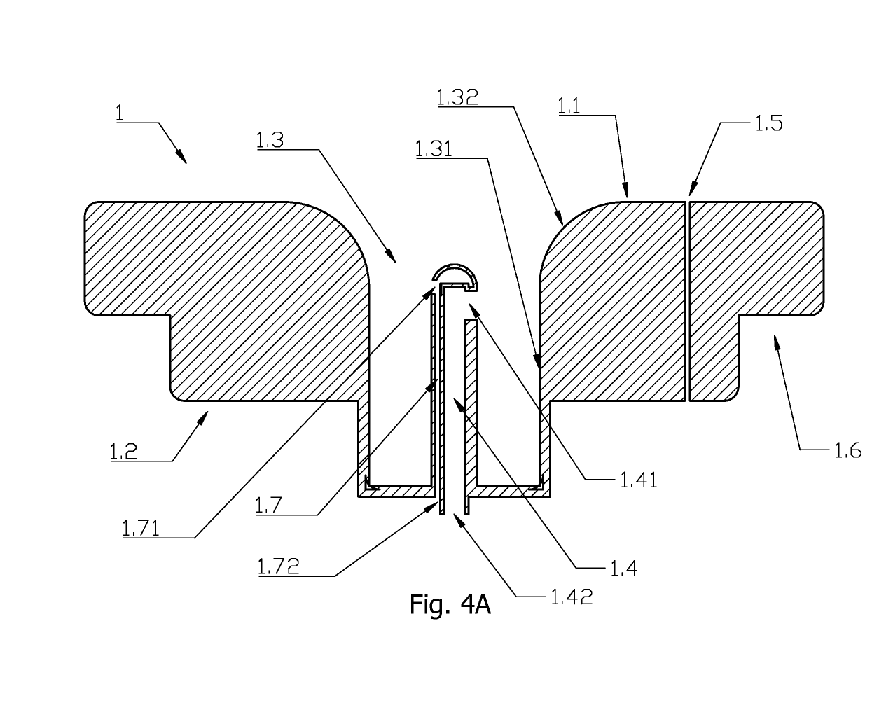

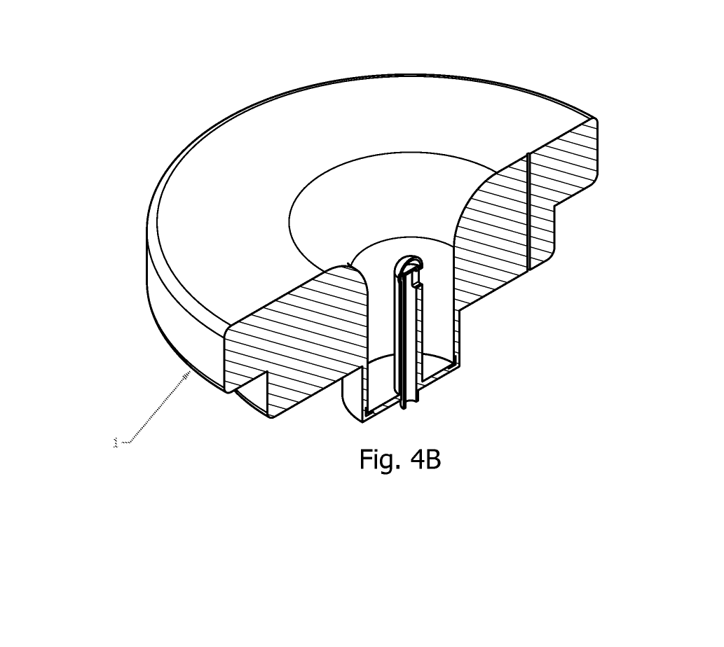

Among the many advantages of the invention An adapter 1 of the invention is provided, as depicted FIGS. 3A-3C and FIGS. 4A-4B. FIGS. 1 and 2 depict the installation of the adapter 1 into a common 5 gallon cooler 2 with a 5 gallon water bottle 3 inserted or otherwise coupled there to.

The adapter 1 comprises a lid having an external side 1.1 and a luminal side 1.2. When installed, the external side 1.1 faces outwardly and/or towards a water bottle while the luminal side 1.2 faces and encloses the lumen of a common 5 gallon container.

The adapter 1 further comprises a collar 1.3 configured for receiving the neck 3.1 of a bottle (e.g. 5 gallon water bottle) and a flow tube 1.4 configured to transmit water from the lumen of the bottle, when inserted into the adapter, and the luminal side 1.2 of the lid. The flow tube 1.4 has an inlet 1.41 that is positioned for insertion in to a 5 gallon water bottle and an outlet 1.42 positioned about the luminal side 1.2. The collar 1.3 comprises a cylindrical portion 1.31 to accept the neck 3.1 of a 5 gallon water bottle and a tapered portion such as funnel 1.32 configured for supporting the shoulder portion of a water bottle and/or for guiding the neck 3.1 of the bottle into the cylindrical portion 1.31 of the adapter 1.

The adapter further comprises a breather configured to provide free water flow from an inserted bottle to the cooler. The breather works, e.g. by transporting air into the water bottle to prevent water flow stoppage due to the creation of a vacuum in the water bottle. The breather comprises an air tube configured to transmit air to the lumen of a 5 gallon water bottle from the luminal side of the lid, the external side of the lid, or both. For example, the breather can comprise an air tube 1.7 with an inlet 1.72 on the luminal side 1.2 of the lid and an outlet 1.71 positioned for insertion in to a 5 gallon water bottle. The breather optionally further comprises an air tube 1.5 having an inlet on the external side 1.1 of the lid and an outlet on the luminal side 1.2 of the lid. With the use of two air tubes 1.5 and 1.7, air can be transmitted from the external environment into the lumen of the 5 gallon cooler by air tube 1.5 and then into the lumen of the water bottle with air tube 1.7. Optionally, air tube 1.7 and flow tube 1.4 share a common housing (e.g. wherein the flow tube runs up through the air tube, as depicted in FIG. 4A and FIG. 4B, e.g. as detailed in U.S. Pat. No. 6,167,921 (Busick et al.; 2001)). The common housing provides an upward projection that can be inserted into the neck 3.1 of a bottle. Accordingly, the common housing can be configured (e.g. sized and shaped) to fit a hole 3.2 in the neck 3.1 of the bottle 3 and position the flow tube 1.4 and air tube 1.7 appropriately in the lumen of a bottle 3, when inserted.

Optionally, the lid of adapter 1 comprises a lip 1.6. A lip 1.6 can be configured, e.g. to provide a first portion of the lid that sits atop the container and a second portion of the lid that sits in the lumen of the container (e.g. as in an internal lip) or that sits outside the container (eg. as in an external lip). Optionally, the lip is configured to provide a snug (e.g. water tight, air tight, or debris-tight) lid for the container (e.g. common 5 gallon cooler).

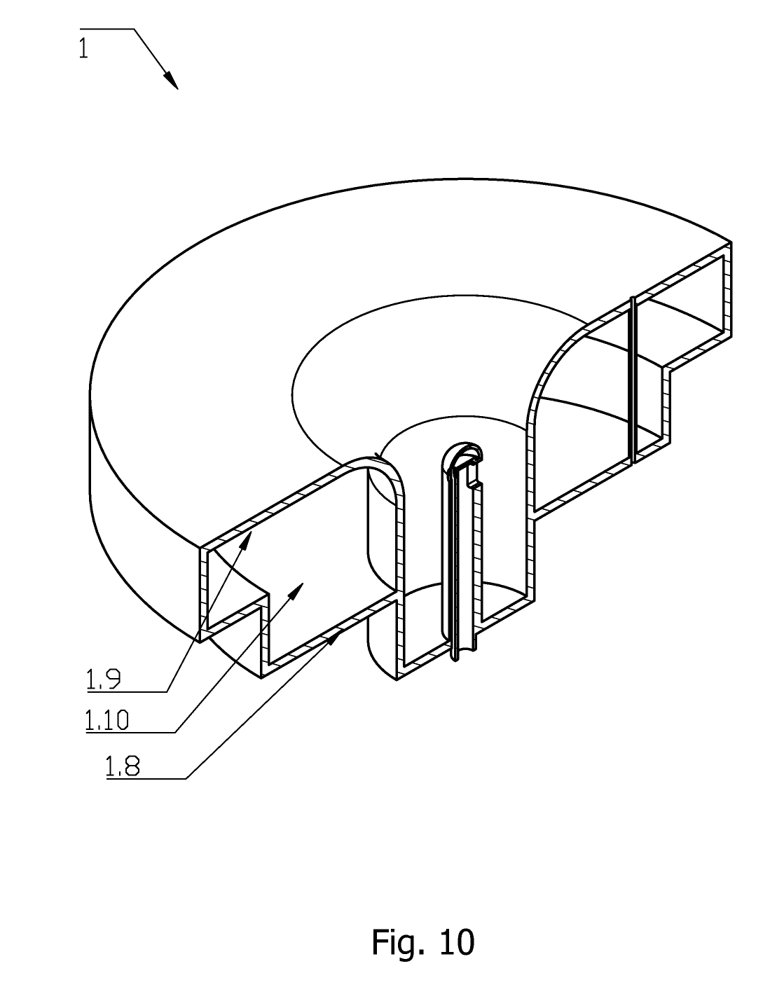

Optionally, the adapter 1 comprises a lid with a three layer configuration, as depicted in FIG. 10. In such a configuration, the lid can comprise a first layer 1.9 on the external side and a second layer 1.8 on the luminal side (e.g. layers made from the same or different plastics). Optionally, the lid further comprises a third layer sandwiched between the first and second layers configured to suppress heat transfer from the external side 1.1 to the luminal side 1.2. The third layer can be, e.g. a layer of insulation (e.g. solid such as polymer, polymer foam, a plastic, a plastic foam, fiberglass foam, or polyurethane foam, a gas such as air, or a void or vacuumed space). Optionally, the first and second layers are formed as a shell (e.g. plastic shell such as polyethylene), as depicted in FIG. 10.

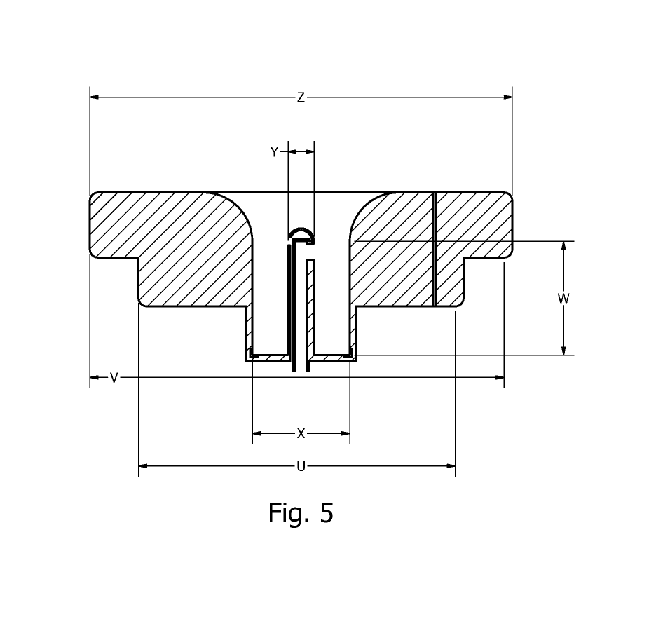

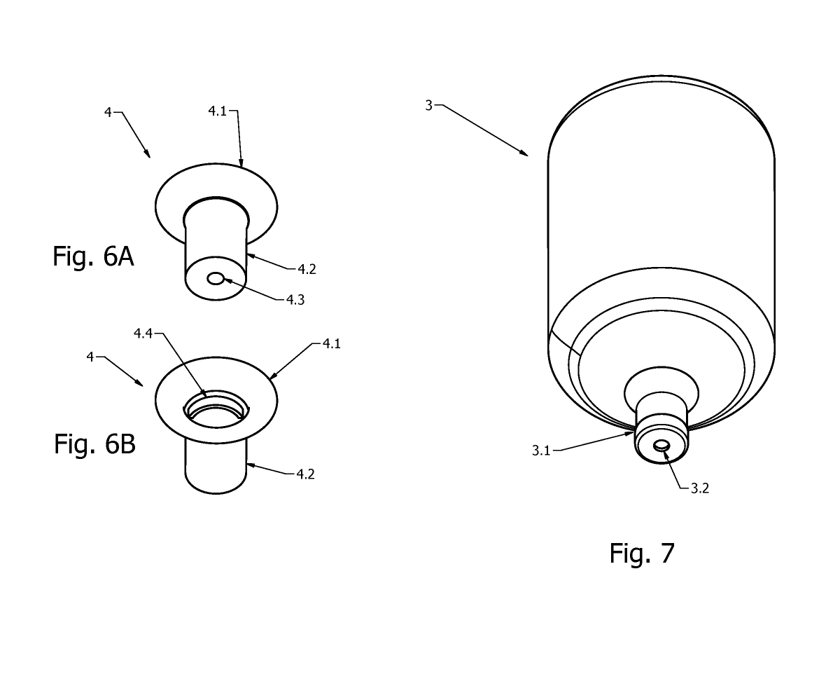

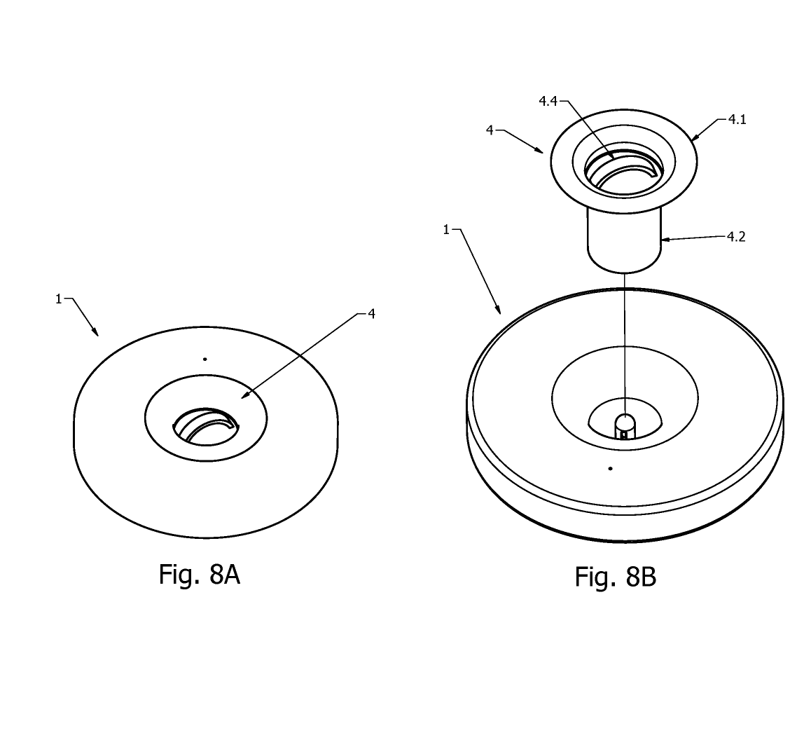

Optionally, the adapter 1 further comprises a removable cover 4, e.g. as depicted in FIG. 6., FIG. 8A and FIG. 8B The removable cover 4 is optionally configured in any manner that covers flow tube 1.4 when installed, as depicted in FIG. 8A and FIG. 8B. Optionally, the removable cover 4 comprises a portion configured to cover the collar 1.3, e.g. as depicted in FIG. 8A and FIG. 8B. Additionally or alternatively, the removable cover 4 can comprises a portion 4.2 configured for insertion into the collar 1.3, e.g. as depicted in FIG. 8A FIG. 8B. Such a portion 4.2 can optionally be shaped like the neck of a 5 gallon water bottle (e.g. with a diameter of about 2.5 inches). Optionally, the removable cover 4 comprises a handle 4.4.

Remarkably, the adapter substantially increases the capacity of containers, even high-capacity containers such as those greater than 3 gallons. For example, an adapter configured to couple a 5 gallon water bottle to a common 5 gallon cooler effectively doubles the capacity of cooler to 10 gallons.

### Example 2

### Cooler of the Invention

A cooler of the invention is provided. The cooler comprises a high-capacity beverage container 2, and an adapter 1 (e.g. as detailed in Example 1) configured for coupling a bottle 3 to the high-capacity beverage container 2. For example, as the beverage high-capacity container 2, a common 5 gallon cooler is provided that is substantially cylindrical. The container comprises a liquid spout 2.6 configured for dispensing liquid from the container. Optionally, the cooler further comprises the bottle 3 (e.g. 5 gallon water bottle with a neck about 2.5 inches in diameter).

The container optionally comprises handles 2.5.

Optionally, the container 2 has a shell comprising a luminal layer 2.3 and an external layer 2.2. Optionally, the shell further comprises an insulation layer 2.4 between the luminal layer 2.3 and the external layer 2.2. Optionally, the insulation layer comprises a gas, a solid, or a void or vacuum space. Optionally, the solid comprises a foam, a polymer, a plastic, a plastic foam, or a polymer foam (e.g. polyurethane foam).

Although any materials may be used for the shell or for the first and second layers, the exterior layer 2.2 is optionally comprises polyethylene (e.g. high-density) and the luminal layer 2.3 optionally comprises polypropylene.

The lip portion of the lid of the adapter is optionally configured to provide a snug fit in the container 2. Optionally, the lip offset is the same as the width of the container shell.

### Example 3

### Adapter to Retrofit a 5 Gallon Cooler with 5 Gallon Water Bottle

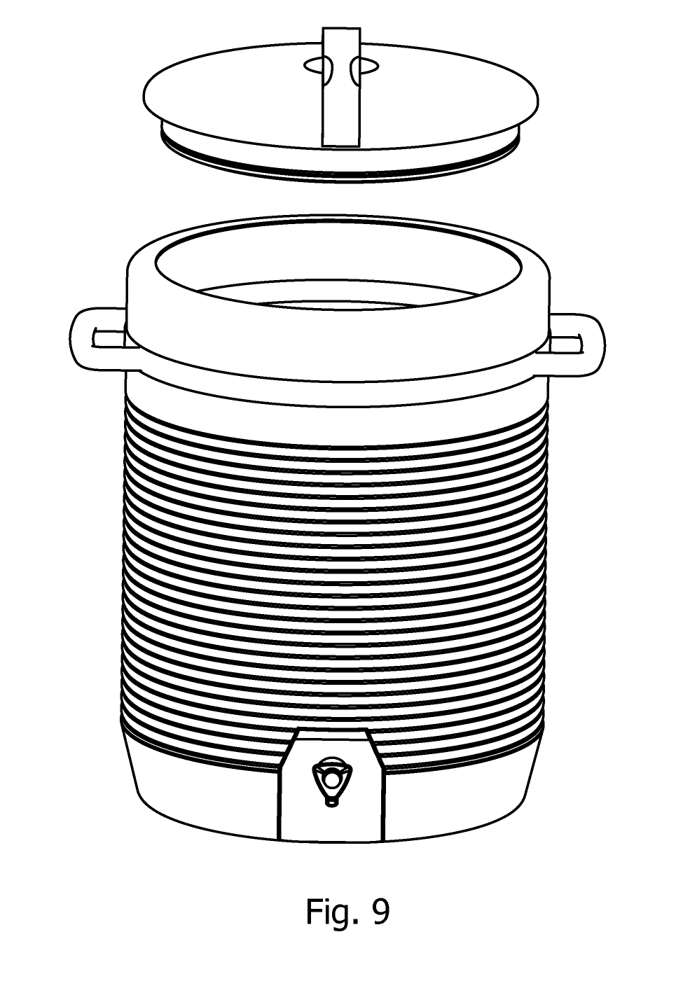

Three common 5 gallon coolers were obtained from different manufacturers. Each was substantially cylindrical, as depicted in FIG. 9. Of the three 5 gallon coolers, two had lumens with a diameter of about 10 inches, and the third cooler had a lumen with a diameter of about 1.5 inches. The smaller coolers had outer diameters ranging from about 11 inches to about 13 inches.

A common 5 gallon water bottle was also obtained. It had a neck 3.1 with a diameter of about 2.5 inches.

An adapter of the invention was constructed to couple the 5 gallon water bottle to the one of the common 5 gallon coolers. The cooler had an inner diameter of 10 inches and an outer diameter of 12 inches. Accordingly, an adapter was provided having a lid an outer diameter of 12 inches with a lip (dimension V) of 1 inch to provide a luminal portion with a diameter (diameter U of FIG. 5) of 10 inches. The adapter had a collar with a diameter X of 3 inches to provide ¼ inch clearance around the neck of the bottle when inserted. Further, the adapter had a projection comprising the flow tube and air tube, wherein the projection diameter Y was about ¾ inches (sized to fit a ¾ inch hole (i.e. hole 3.2 in FIG. 7)).

The adapter of the invention provided a snug fit in the common 5 gallon cooler and supported the common 5 gallon water bottle with the collar. A graphical depiction is illustrated in FIG. 1 and FIG. 2. As a comparator, a 5 gallon water bottle inlet from an office water cooler was also obtained. The 5 gallon bottle inlet was of the type having a collar configured for acceptance of the neck of a 5 gallon bottle, e.g. as described by U.S. Pat. No. 6,167,921 (Busick et al.; 2001). With the typical collar diameter of about 3 inches and outer diameter of only a few additional inches, the 5 gallon bottle inlet from the office cooler was not configured for the common 5 gallon cooler. For example, the 5 gallon bottle inlet from the office cooler too small to even set atop the larger diameter of the common 5 gallon coolers.

### Example 4

### Use of Cooler with Adapter During Team Athletic Event

Two athletic teams compete in an athletic event. Each team has a large number of athletes.

The first team has a common 5 gallon water cooler filled with water, as is known in the prior art. During game play, water from the water cooler is gradually depleted and consumed by athletes of the first team. The first team does not realize that the water cooler is nearly empty prior to a scheduled break in team play. During the scheduled break, the entire team of athletes prepares to consume water, however, the water cooler is completely depleted after only a few athletes are able to retrieve water from the water cooler. Upon discovery of the completely depleted water cooler, the team manager obtains additional water to fill the water cooler, a process that takes several minutes. The scheduled break ends before the rest of the athletes are able to retrieve water from the water cooler. This unplanned event leaves the several athletes on the first team dehydrated before returning to game play. Dehydration in an active sport, especially outdoors on a hot day, can be a dangerous condition for an athlete and can affect athletic performance.

In contrast, the second team has a cooler of the invention (e.g. as detailed in Example 2) which comprises an adapter of the invention on a 5 gallon container having a 10 inch mouth. The 5-gallon container is filled with water. Then, a 5 gallon water bottle containing 5 gallons of water is inverted and inserted into the collar of the adapter. As with the first team, water from the water cooler is gradually depleted and consumed by athletes of the second team during game play. As with the first team, nearly 5 gallons of water is depleted from the water cooler prior to the schedule break in game play. However, in contrast to the first team, upon depletion of the original 5 gallons of water in the container, the water from the inverted water bottle drains into the container to keep the reservoir full. Further, upon complete depletion of water from the water bottle, the team manager obtains a second water bottle to replace the first water bottle. Not only the water change for the second team much faster than the first team, but the water cooler still contains 5 gallons of water during the water change. Thus, even with a completely depleted water bottle, the entire second team can obtain water from the water cooler during the water change, prior to the end of the schedule break. In contrast to the first team, the entire second team returns to game play refreshed with water. As observed in this example, the present invention prevents dehydration of athletes of the second team. Accordingly, the present invention provide a mechanism to serve large amounts of people in a short period of time, e.g. concurrently with a water refilling process, and provides a mechanism to serve people, even after it is realized that water refilling is needed.

### Example 5

### Use of Cooler with Adapter in Remote Locations

A golf course having 18 holes includes a cooler of the invention at the T-off (start) of a few holes. The T-off location of these holes are several miles from the club house, which contains the course's supply of back-up water. Each cooler of the invention (e.g. as detailed in Example 2) comprises an adapter of the invention on a 5 gallon container having a 10 inch mouth. The 5-gallon container is filled with water. Then, a 5 gallon water bottle containing 5 gallons of water is inverted and inserted into the collar of the adapter. Upon depletion of the original 5 gallons in the container, water from the inverted water bottle drains to refill the container. Upon complete depletion of the water from the water bottle, it is reported to the club house that the water cooler needs a replacement water bottle. Due to the distance of the water cooler form the club house and limited staff availability, it takes a substantial amount of time to replace the empty water bottle with a full water bottle. However, during this interim, the water cooler still contains a substantial amount of water to refresh a large number of golfers prior to replacing the water bottle. This is in contrast to the same golf course with common 5 gallon water coolers of the prior art that do not include an adapter of the invention. In such a golf course, the water cooler remains empty for a substantial amount of time once it is reported that the water cooler needs refilling. In this latter scenario, several golfers are unable to retrieve before the water cooler is refilled. Accordingly, the present invention provides a mechanism to prevent long periods of empty water coolers, e.g. in situation where the water cooler is far away from a water reserve.

### Example 6

### Use of Ice-Filled Cooler with Adapter Outdoors

A cooler of the invention (e.g. as detailed in Example 2) is provided and comprises an adapter of the invention on a 5 gallon container having a 10 inch mouth. The cooler is provided at an outdoor location without electricity. The 5-gallon container is filled with 5 gallons of ice. Then, a 5 gallon water bottle containing 5 gallons of water is inverted and inserted into the collar of the adapter. By temporary removal of the adapter of the invention, the wide mouth of the container allows the quick refilling of ice (e.g. by quick dumping from a bag of ice) and the high capacity of the 5 gallon container holds a substantial amount of ice such that the ice can cool a substantial amount of water before completely melting. This is in contrast to a low capacity container without a wide mouth (e.g. as seen in electric office water coolers or other container known in the prior art that contain a collar for receiving an inverted water bottle), in which, even if it had a removable cover would not allow quick refilling with ice due to the small mouth and would hold only a minimal amount of ice, if any, such that the ice would quickly melt upon the container receiving water from the water bottle. Accordingly, the invention provides an efficient mechanism to cool water, even in locations that do not have electricity. This feature is useful in any scenario, e.g. in the scenarios detailed in Examples 4 and 5.

The citations provided herein are hereby incorporated by reference for the cited subject matter.

What is claimed is:

1. An adapter comprising:
a lid configured to cover a container having a mouth diameter of at least about 8 inches (‘wide mouth container’), wherein the lid comprises an external side and a luminal side configured to face the lumen of a container;
a collar located on the external side of the lid, wherein the collar is configured to receive the neck of a water bottle; and
a flow tube configured to transmit liquid from the lumen of an inserted bottle to the to the luminal side of the lid.

2. The adapter of claim 1, wherein the lid further comprises a lip.

3. The adapter of claim 1, further comprising a breather configured to transmit air to the lumen of an inserted bottle.

4. The adapter of claim 3, wherein the breather is configured to transmit air to the lumen of an inserted bottle from either the luminal side of the lid, the external side of the lid, or both.

5. The adapter of claim 4, wherein the breather comprises an air tube positioned about the flow tube.

6. The adapter of claim 5, further comprising a common housing comprising the flow tube and the air tube, wherein the common housing is configured as a tube connecting the luminal side and external side, and extends out on the external side of the lid through the collar.

7. The adapter of claim 5, wherein the breather comprises a second air tube configured to transmit air from the external side at a location outside the collar to the luminal side of the lid.

8. The adapter of claim 1, wherein the lid is substantially circular in cross-section.

9. The adapter of claim 8, wherein the lid has a diameter of greater than about 8 inches.

10. The adapter of claim 9, wherein the diameter is between about 9 inches and about 18 inches.

11. A cooler comprising:
a. a wide mouth container; and
b. the adapter of claim 1, wherein the adapter is configured to transmit fluid from a bottle to the container.

12. The cooler of claim 11, wherein the container is substantially cylindrical.

13. The cooler of claim 11, wherein the container comprises a luminal layer and an external layer.

14. The cooler of claim 13, wherein the container further comprises an insulation layer between the luminal layer and the external layer.

15. The cooler of claim 14, wherein the insulation layer comprises air, a vacuum, or a solid material.

16. The cooler of claim 15, wherein the solid material comprises a foam, a polymer, a polyurethane, a polymer foam, or a polyurethane foam.

17. The cooler of claim 11, wherein the container is not an electric refrigerator.

18. The cooler of claim 11, wherein the container is a wide-mouth container.

19. The cooler of claim 11, wherein the container has a volume of at least 5 gallons; and

20. A method of increasing the capacity of a container comprising:
a. providing a wide-mouth container comprising an open top;
b. covering the open top with the adapter of any of claim 1; and
c. inserting an inverted bottle into the collar of the adapter.
